(19) United States
(12) Patent Application Publication
(10) Pub. No.: US 2018/0288618 A1
(43) Pub. Date: Oct. 4, 2018

(54) BOOTSTRAPPING IN A SECURE WIRELESS NETWORK

(71) Applicant: PHILIPS LIGHTING HOLDING B.V., Eindhoven (NL)

(72) Inventors: SANDEEP SHANKARAN KUMAR, WAALRE (NL); PETRUS DESIDERIUS VICTOR VAN DER STOCK, HELMOND (NL); PETRUS JOHANNES LENOIR, 'S-HERTOGENBOSCH (NL); THEODORUS JACOBUS JOHANNES DENTENEER, EINDHOVEN (NL)

(21) Appl. No.: 15/525,189

(22) PCT Filed: Oct. 28, 2015
(86) PCT No.: PCT/EP2015/074916

§ 371 Date: May 8, 2017

(30) Foreign Application Priority Data
Nov. 7, 2014 (EP) 14192247.6

(51) Int. Cl. H04W 12/08; H04L 29/06; H04W 12/06; G06F 9/4401

(52) U.S. Cl. CPC H04W 12/08; G06F 9/4416; H04W 12/06; H04L 63/205

(57) ABSTRACT

A wireless network (252) has a mesh structure of wireless communication links between nodes (210, 220). The network enables an unsecured node (230) to join the network by exchanging joining messages with a configurator (200). The configurator (200) is arranged for determining network security states including an insecure state in which all nodes are in the unsecured mode and the network is open for joining nodes; a partially secure state in which at least one node (210, 220) is in the secured mode and the network is open for joining nodes; and a secure state in which the network is closed to nodes in the unsecured mode. The nodes detect the security state and adapt their operation to the detected security state of the network and the mode of the device. The adapted operation enables flexible security bootstrapping of the network.

### FIELD OF THE INVENTION

The invention relates to a network system comprising network devices, a border router and a configurator. The network devices and the border router constitute nodes in a wireless network having a mesh structure of wireless communication links between the nodes. The border router may be connected to the configurator via a backbone. The wireless network enables a node, which is operating in an unsecured mode, to join the wireless network by exchanging joining messages with the configurator. The joining messages enable the joining node to operate in a secured mode.

The invention further relates to a configurator, a network device, a border router, a method of configuring, a method of controlling a network device, a method of controlling a border router, and a computer program product for use in the network system.

In wireless networks, for example wireless control networks comprising wireless lighting units and sensors, security protocols are used to bootstrap security and ensure security services. Such networks have a mesh structure of wireless communication links between multiple nodes, also called multi-hop networks.

### BACKGROUND OF THE INVENTION

The document WO2011/045714 describes a method for operating a node in such a wireless multi-hop network system. Joining the wireless network by a new node is achieved by transmitting a first identifier to a second node having a second identifier. Then the first node generates a first key on the basis of the second identifier and the first node authenticates the second node by means of the first key. Finally the first node communicates with a third node if the first and second keys are equal.

US2007/0147620 describes a method for encryption key management for use in a wireless mesh network. A temporary communication route, which is time and use limited, is initiated between a wireless device and an internet access point, when the device initially joins the network.

### SUMMARY OF THE INVENTION

In the known system, if a large number of new nodes need to be added to the wireless network, each new node needs, when joining, to communicate with a node that is already part of the secure network, i.e. that has the credentials and key material required to operate in a secured mode. This type of extending a secure network may be called onion style.

A problem of such a network system is that the joining node needs to communicate with neighboring nodes that are already secure.

It is an object of the invention to provide a network system that enables efficient security bootstrapping for a mesh type wireless network.

For this purpose, a system, devices and methods are provided as defined in the appended claims.

The network system as described in the opening paragraph comprises a number of network devices and at least one border router that constitute the nodes in the mesh type wireless network. The basic role of a border router is an anchor point of a mesh network and a gateway to other elements connected to the system. The configurator is coupled to the network, either via the backbone or via a wireless link to one or more nodes, so as to enable a joining node that is not configured and/or is operating in an unsecured mode, to join the network by exchanging joining messages with the configurator, which configurator authenticates the joining node based on the joining messages and enables, via the joining messages, the joining node to operate in a secured mode.

The configurator comprises a configurator controller arranged for determining network security states. The network security states are controlled and enforced by the configurator so as to determine the level of secure operations and communication. Thereto the nodes will receive configuration information from the configurator, for example the nodes will detect the network security state from configuration items that instruct the node how to handle messages. The security states include an insecure state in which all nodes are in the unsecured mode and the wireless network is open for joining nodes; a partially secure state in which at least one node is in the secured mode and the wireless network is open for joining nodes; and a secure state in which the wireless network is closed to nodes joining in the unsecured mode. Effectively, the security states enable multiple levels of protection against intruders and other malicious or malfunctioning devices, while still enabling new nodes to join the wireless network by initially setting, or temporarily changing, the security state to the partially secure state.

The network device comprises a transceiver for wirelessly receiving data frames from neighboring nodes and transmitting data frames to the neighboring nodes, and a device controller for, according a detected network security state, controlling the transceiver on a network layer and transferring data frames between the transceiver and higher communication layers in the network device. The device controller is arranged for, when in unsecured mode, controlling data frames from the higher communication layers to be transmitted unsecured; controlling received unsecured data frames, if destined to the network device, to be accepted by the higher communication layers; and forwarding received unsecured data frames to the further nodes. Also the device controller is arranged for, when in secured mode, controlling data frames from the higher communication layers to be transmitted secured; controlling received secured data frames, if destined to the network device, to be accepted by the higher communication layers; when the detected network security state is the partially secure state, forwarding received unsecured and secured data frames to the further nodes; and when the detected network security state is the secure state, dropping received unsecured data frames and forwarding received secured data frames to the further nodes.

The border router comprises a border transceiver for wirelessly receiving data frames from neighboring nodes and transmitting data frames to the neighboring nodes, a backbone transceiver for receiving data frames from the backbone and transmitting data frames to the backbone, and a border controller for, according to a detected network security state, controlling the border transceiver and the backbone transceiver on a network layer. The border controller is arranged for, when in unsecured mode, forwarding received unsecured data frames to the further nodes. Also, the border controller is arranged for, when in secured mode, when the detected network security state is the partially secure state, forwarding received unsecured and secured data frames to the further nodes or the backbone; and when the detected network security state is the secure state, dropping received unsecured data frames and forwarding received secured data frames to further nodes or the backbone.

The method of configuring as described in the opening paragraph comprises authenticating a joining node based on joining messages and enabling, via the joining messages, the joining node to operate in a secured mode, and determining network security states including an insecure state in which all nodes are in the unsecured mode and the wireless network is open for joining nodes; a partially secure state in which at least one node is in the secured mode and the wireless network is open for joining nodes; and a secure state in which the wireless network is closed to nodes in the unsecured mode.

The method of controlling a network device as described in the opening paragraph comprises according a detected network security state, controlling a transceiver on a network layer and transferring data frames between the transceiver and higher communication layers in the network device, as follows. The method, when in unsecured mode, controls data frames from the higher communication layers to be transmitted unsecured; controls received unsecured data frames, if destined to the network device, to be accepted by the higher communication layers; and forwards received unsecured data frames to the further nodes. The method, when in secured mode, controls data frames from the higher communication layers to be transmitted secured; controls received secured data frames, if destined to the network device, to be accepted by the higher communication layers. The method, when the detected network security state is the partially secure state, forwards received unsecured and secured data frames to the further nodes; and when the detected network security state is the secure state, drops received unsecured data frames and forwards received secured data frames to the further nodes.

The method of controlling a border router as described in the opening paragraph comprises according to a detected network security state, controlling a border transceiver and a backbone transceiver on a network layer, and, when in unsecured mode, forwarding received unsecured data frames to the further nodes. The method, when in secured mode and when the detected network security state is the partially secure state, forwards received unsecured and secured data frames to the further nodes or the backbone.

Also the method, when in secured mode and when the detected network security state is the secure state, drops received unsecured data frames and forwards received secured data frames to further nodes or the backbone.

It is to be noted that, in this document, unsecured means that there is no protection at all, or that there only is protection using well-known or standardized keys, so that effectively any malicious party can get hold of such keys. Hence an unsecured data frame may mean either a data frame with no security or a data frame protected with a well-known key, for example mentioned in a standard or a factory default key. Secured means that key material and/or credentials have been established and are used which are under the control of a trusted source or authenticator, usually located in the configurator or in a security server accessible via a secure link.

Controlling of the transceivers is defined on a network communication layer. Such transceivers have the function of communicating across the links in the mesh type wireless network, so the control may be at the link layer level. For example, in a layered communication stack the control may be at the medium access level (MAC). In devices accommodating such communication structures the layers above the controlled network layer may be referred to as the higher communication layers, for example including an application layer for communicating to application circuitry like a lighting unit.

The device controller is arranged for controlling received secured data frames, if destined to the network device, to be accepted by the higher communication layers. In this context controlling may include security processing to check the integrity of a secured data frame, if such an integrity code exists in the secured data frame. Failing such a check the device controller may handle the data frame as unsecured.

The invention is, inter alia, based on the following recognition. Individual devices in a traditional network may either work in unsecure mode or secure mode. For security reasons a new node will receive its credentials only at the border of the already secured part of the wireless network. This means that joining of new nodes is limited to an onion type of extending the number of secure mode nodes. Traditionally the secured part may grow like an onion by adding shells of new nodes. However, the inventors noted that, in practice, often various groups of network devices are installed in various locations, and have to be configured (also called commissioned) to be part of a secure network system. There appears to be a practical requirement to start commissioning at any point. By introducing the global network security states, and enforcing all network devices to detect the state, the operation of the network devices is made dependent on the network security state. Hence security of the total network system may be adjusted by setting the nodes to a specific security state in addition to the nodes having their own key material which enables the nodes as such to operate in a secured mode. Furthermore, the partially secure state of the wireless network enables flexible commissioning, because any cluster of devices may be secured while the joining messages still have to travel across unsecured nodes to reach the configurator. Now connected groups of devices may be provided with credentials and go to secured mode, while other parts of the wireless network are still insecure. The insecure part may even fully enclose such groups of secured devices. Hence, by providing the partially secure state, a type of configuring is enabled which may be called an “island type” of commissioning. After the commissioning has been completed, the global network security is increased by switching the network security state to the secure state. So, finally a high level of security is achieved by defining strictly secure operation in the secure state, while the joining of new devices may be enabled at any time by temporarily going back to the partially secure state.

Furthermore, a computer program may implement each one of the methods, and may be provided on a medium such as an optical disc or memory stick.

Further preferred embodiments of the devices and methods according to the invention are given in the appended claims, disclosure of which is incorporated herein by reference.

### BRIEF DESCRIPTION OF THE DRAWINGS

These and other aspects of the invention will be apparent from and elucidated further with reference to the embodiments described by way of example in the following description and with reference to the accompanying drawings, in which

FIG. 1 shows prior art security services in communication layers for a wireless network,

FIG. 2 shows a network system comprising network devices, a border router and a configurator,

FIG. 3 shows an example of a topology of a network system, and

FIG. 4 shows an example of network security states and state transitions.

The figures are purely diagrammatic and not drawn to scale. In the Figures, elements which correspond to elements already described may have the same reference numerals.

### DETAILED DESCRIPTION OF EMBODIMENTS

Wireless control networks represent a ubiquitous trend in building management systems. The independence from physical control wires allows for freedom of placement, portability and for reducing the cost of installation (less cable placement and drilling required). Further wireless networks of devices, also called the of Internet of Things, involve an ever growing number of nodes, i.e. electronic devices being network connected and communicating with services or other connected devices.

In addition, the drive for lower cost of these wireless network nodes means that the node resources (low-clock CPU, small RAM, and small Flash storage) will be limited. Some of these devices will be battery-operated or powered by scavenged energy. In these cases the devices should operate with very low power consumption. Also communication bandwidth is limited, e.g. based on the IEEE 802.15.4 wireless network standard (see ref [IEEE15.4]; reference documents are listed at the end of this description).

Securing such a wireless control networks is very important to ensure the integrity, availability and often confidentiality of the control and data transferred over the network. Security can be enabled at various layers of the networking stack to ensure a secure end-to-end network. The IEEE 802.15.4 MAC layer has provisions for enabling link-layer security using AES [AES] cipher suites for confidentiality and integrity of MAC frames. IPsec [IPsec] could be used to secure the IP layer but is often considered heavy-weight for such constrained environments. CoAP requires the use of DTLS 1.2 [DTLS] for securing the CoAP messages over User Datagram Protocol (UDP), which is one of the core members of the Internet protocol suite. Constrained Application Protocol [CoAP] is a software protocol intended to be used in simple electronics devices that allows them to communicate interactively over the Internet. It is particularly targeted for small low power sensors, switches, valves and similar components that need to be controlled or supervised remotely, through standard Internet networks. CoAP is an application layer protocol that is intended for use in resource-constrained internet devices. CoAP is designed to easily translate to HTTP for simplified integration with the web, while also meeting specialized requirements such as multicast support, very low overhead, and simplicity.

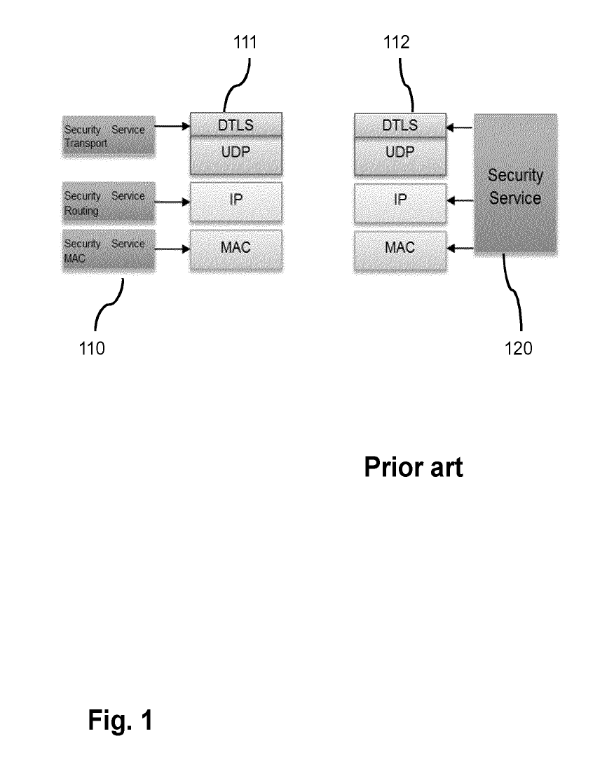

FIG. 1 shows prior art security services in communication layers for a wireless network. The Figure shows, on the left side, a traditional communication layer structure 111 having separate security control units 110 providing security services. In the layer structure a first unit provides a MAC security for the medium access (MAC) layer, a second unit provides routing security service on the internet protocol (IP) layer. A further layer defines the UDP. On top of the structure, a third security unit provides transport security services to the DTLS layer. The Figure shows, on the right side, a lightweight communication layer structure 112, also called a lightweight IP stack, having a single security control unit 120 providing combined security services. The communication layer structure 112 has the same layers as the traditional structure.

In the traditional structure security needs to be enabled at multiple layers in the stack to fulfill different functionalities: link-layer security for hop-by-hop security; datagram transport level security (DTLS) for end-to-end security extending over multiple different link-layers. However due to the constrained nature of the network nodes, re-use of cryptographic primitives and protocol elements is proposed across these layers, as illustrated by the lightweight structure 112. An example is the reuse of AES-CCM [AES-CCM] cipher mode for both link-layer security and DTLS security. Additionally, the security services running at different stack layers on the device which determine how incoming, outgoing and forwarding of network packets are handled at the different layers, can be combined into the single security service unit 120 which allows for cross-layer optimizations in the lightweight IP stack.

A problem in creating a secure wireless network is the secure authentication of devices that join the network, also called the network access control (NAC) of devices. This requires joining messages according to a bootstrapping protocol to authenticate a joining node (JN) to a network configurator (NC) using credentials which can used to securely verify the JN's identity. Based on authorization rules on the NC, the NC can either allow or deny access of JN to the network. So the configurator is for authenticating the joining node based on the joining messages and via the joining messages enabling the joining node to operate in a secured mode.

In a prior art example, secure NAC protocols for IEEE 802.3 Ethernet LAN and IEEE 802.11 Wi-Fi are well established based on the IEEE 802.1X Port based Network Access Control. 802.1X uses Extensible Authentication Protocol (EAP) [EAP] framework to perform network authentication with a backend authentication server. EAP is sent over EAP-over-LAN (EAPOL) frames between the joining node (Supplicant) to the Authenticator (Authenticator is usually located on a border router) which then contacts backend authentication server by exchanging EAP frames using the RADIUS protocol [RADIUS] with the Authentication server.

The prior art example requires that the JN is one-hop away from the Authenticator. In a multi-hop mesh network like IEEE 802.15.4, the JN can be multiple hops away from the Authenticator. Since IEEE 802.15.4 does not include a routing protocol, it prevents the use of an EAPOL type mechanism. Therefore standardization bodies have defined the use of PANA [PANA] as a carrier transport for the EAP frames. Additionally to solve the multi-hop routing issue, PANA uses a PANA Relay Element (PRE) [PRE] which is single hop from the JN to route packets from JN to the authenticator

In the prior art example, disadvantages of PANA and EAP based NAC in constrained networks are the following. A large number of round-trips (e.g. around 10) may be required to complete the NAC, which leads to a high probability of delay/failure to complete the protocol in a wireless network. Also, the known system allows for only an onion style of bootstrapping. In onion style the nodes that are one-hop away from the Border Router are first bootstrapped, and then a second “onion layer” of nodes a next hop away, etc. So subsequent onion layers of nodes are bootstrapped across additional incremental hops.

The prior art onion type bootstrapping severely limits the order of commissioning a logical group of devices since the onion style is dictated by the physical network structure. Also, multiple new protocols (PANA, EAP) are needed during NAC, which leads to additional code memory on constrained devices. Furthermore, EAP and PANA provide a huge flexibility in the choice of parameter values which are unnecessary for constrained devices. Disadvantageously, the flexibility to negotiate the authentication protocol and parameters requires lengthy handshake on the wireless network.

The proposed system enables Network Access Control for joining devices in a multi-hop wireless mesh network which overcomes the disadvantages mentioned above.

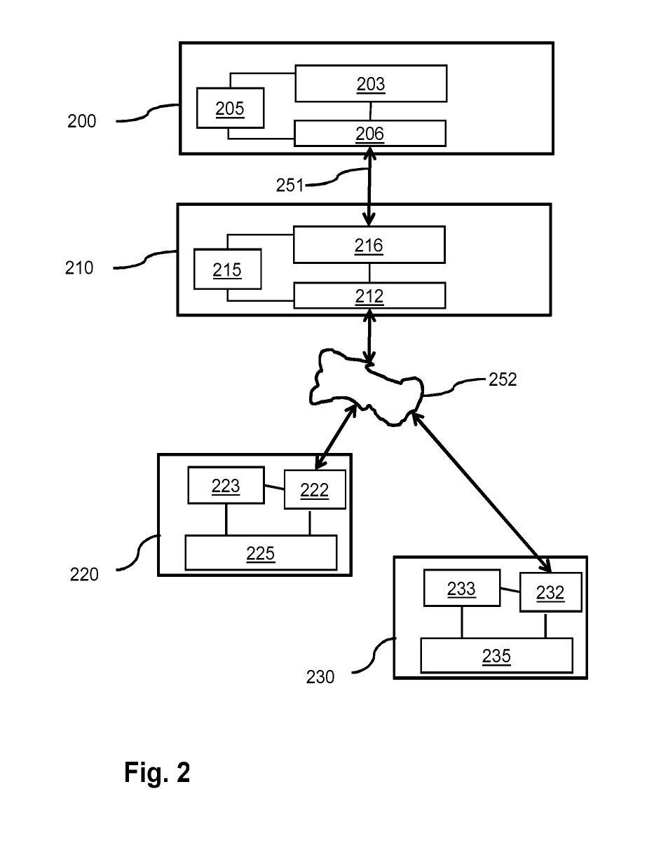

FIG. 2 shows a network system comprising network devices, a border router and a configurator. The network devices 220,230 and the border router 210 constitute nodes in a wireless network 252 having a mesh structure of wireless communication links between the nodes. The border router is shown to be connected to the configurator 200 via a backbone 251. Alternatively, the configurator may also be connected to a different node in the network, e.g. via a wireless link to one of more of the nodes or the border router. The wireless network enables a node, which is operating in an unsecured mode, to join the network by exchanging joining messages with the configurator. The joining messages enable the joining node to operate in a secured mode, e.g. according to a security protocol exchanged between the joining node and the configurator.

The configurator 200 has a communication transceiver 206 to be coupled to the backbone 251. Alternatively, or additionally the communication transceiver may be arranged for wireless communication to the network. The configurator may include an authenticator 203 that manages the security data. The authenticator may be a function on an application layer which is coupled to the transceiver which is on a network layer. Alternatively, the authenticator function may be located in a separate device, e.g. a server coupled to the backbone or accessible via the internet.

The configurator further has a configurator controller 205 arranged for determining network security states. The network security states include an insecure state in which all nodes are in the unsecured mode and the wireless network is open for joining nodes; a partially secure state in which at least one node is in the secured mode and the wireless network is open for joining nodes; and a secure state in which the wireless network is closed to nodes in the unsecured mode. Further details of the network security states, and the operation of the various devices in dependence of the network security states, are provided below.

The network device 220 has a transceiver 222 for wirelessly receiving data frames from neighboring nodes and transmitting data frames to the neighboring nodes, and a device controller 225 for, according a detected network security state, controlling the transceiver on a network layer. For example, the network layer may be a medium access (MAC) layer. In devices accommodating such communication structures the layers above the network layer may be referred to as the higher communication layers. The network layer is coupled to higher communication layers 223 that provide a communication stack, well known as such. The device further may further have application elements and circuitry (not shown) coupled to the communication stack, for example a lighting unit that is controlled via a dimmer. The device controller is further arranged for transferring data frames between the transceiver and the higher communication layers in the network device. For example, the network device 220 may be in secured mode.

The device controller is operational either in unsecured mode or secured mode, in dependence of security credentials acquired when joining the wireless network. Further detailed security modes may also be defined. The device controller is arranged for, when in unsecured mode, controlling data frames from the higher communication layers to be transmitted unsecured; controlling received unsecured data frames, if destined to the network device, to be accepted by the higher communication layers; and forwarding received data frames to the further nodes. Also the device controller is arranged for, when in secured mode, controlling data frames from the higher communication layers to be transmitted secured; and controlling received secured data frames, if destined to the network device, to be accepted by the higher communication layers. Furthermore, the device controller in secured mode is arranged for, when the detected network security state is the partially secure state, forwarding received data frames to the further nodes; and when the detected network security state is the secure state, dropping received unsecured data frames and forwarding received secured data frames to the further nodes,

A second network device 230 has a transceiver 232 for wirelessly receiving data frames from neighboring nodes and transmitting data frames to the neighboring nodes, and a device controller 235 for, according a detected network security state, controlling the transceiver on a network layer. The network layer is coupled to higher communication layers 233. For example, the second network device may be in unsecured mode. Further network devices may be present (not shown) to constitute further nodes and have similar elements. The function of the second and further network devices are equal to function of the network device described above.

The border router 210 has a border transceiver 212 for wirelessly receiving data frames from neighboring nodes and transmitting data frames to the neighboring nodes, a backbone transceiver 216 for receiving data frames from the backbone and transmitting data frames to the backbone, and a border controller 215 for, according to a detected network security state, controlling the border transceiver and the backbone transceiver on a network layer. Also, the border router may be arranged for routing the joining messages between the nodes and the configurator. The border controller is arranged for, when in unsecured mode, forwarding received data frames to the further nodes. Also the border controller is arranged for, when in secured mode, when the detected network security state is the partially secure state, forwarding received data frames to the further nodes or the configurator; and when the detected network security state is the secure state, dropping received unsecured data frames and forwarding received secured data frames to further nodes or the configurator.

Optionally, for use in the network system as described above, in the configurator the configurator controller is arranged for determining the network security states by sending a network lock message to set the network security state to the secure state; and sending a network unlock message to set the network security state to the partially secure state. Also, in the network device, the device controller is arranged for setting the detected network security state to the secure state when receiving the network lock message, and for setting the detected network security state to the partially secure state when receiving the network unlock message. By transferring such messages the nodes are set to operate in accordance with the network security state as selected by the configurator. For example a user at the configurator may select the network security state based on the actual status of installation and commissioning in a building. Also, the configurator may automatically select an appropriate security state, e.g. after a predetermined period the configurator automatically sets the system to the secure sate. The period may be a period of no activity, or based on a time of the day, or a time slot assigned for commissioning, etc.

Optionally, for use in the network system as described above, in the configurator, the configurator controller is arranged for determining, as a further network security state, a join state in which the network is closed and the nodes are in the secured mode while enabling joining of a joining node in the unsecured mode and one-hop away of a node in the secured mode. Also, in the network device, the device controller is arranged for, when in secured mode, when the detected network security state is the join state, forwarding received secured data frames to the joining node after unsecuring; and forwarding received unsecure data frames from the joining node after securing. Also, in the border router, the border controller is arranged for, when in secured mode, when the detected network security state is the join state, forwarding received secured data frames to the joining node after unsecuring; and forwarding received unsecure data frames from the joining node after securing. Additionally or alternatively to temporarily going back to the partially secure state when a new node needs to join, the join state may be provided. In the join state, the wireless network is closed and the nodes are in the secured mode while enabling joining of a joining node in the unsecured mode at one-hop away of a node in the secured mode. Effectively, the join state enables the network system to grow in a controlled way, effectively temporarily enabling an onion style of growing. After the joins have been completed, the network may be reset to secure state, e.g. by sending the lock message as described above. Optionally, in the configurator, the configurator controller is arranged for determining the network security states by sending a join edge message to set the network security state to the join state; and in the network device, the device controller is arranged for setting the detected network security state to the join state when receiving the join edge message.

Optionally, for use in the network system as described above, in the network device the device controller is arranged for, when the detected network security state is the partially secure state and if routing enables two paths, routing to the path where the next link is secured. In the border router the border controller may be arranged for, when the detected network security state is the partially secure state and if routing enables two paths, routing to the path where the next link is secured. By applying such routing, the data is guided via the secure part of the network.

Optionally, for use in the network system as described above, in the network device the device controller is arranged operating as follows when the detected network security state is the partially secure state. If receiving an unsecured frame from an unsecured node and forwarding to an unsecured node, the frame is forwarded unsecured; if receiving an unsecured frame from an unsecured node and forwarding to a secured node, the frame is secured before forwarding; if receiving a secured frame from an secured node and forwarding to an unsecured node, the frame is first unsecured before forwarding; and if receiving an unsecure frame from a secured node, the frame is dropped. Additionally or alternatively to the joining messages remaining unsecured during transfer in the partially secure state, further security is provided by modifying the joining messages to secured data frames while being transferred between secured nodes. Such messages are unsecured when leaving a secured “island” for further transfer to the joining node or configurator. Effectively, a conversion is performed at the boundary of a secured part of the network to an unsecured part. Traffic of unsecured frames is restricted by dropping the unsecure frames from secured nodes.

Optionally, for use in the network system as described above, in the network device, the device controller is arranged for routing the joining messages from the joining node only towards the border router and joining messages from the border router back to the joining node. Also, in the border router the border controller may be arranged for routing the joining messages from the joining node only towards the border router and joining messages from the border router back to the joining node. By restricting the available routes for the joining messages the possible unnecessary or malicious distribution of joining messages is prevented.

Optionally, for use in the network system as described above, in the border router the border controller may be arranged for, if a first communication link in a path is to a secured node, securing a data frame from the backbone and then forwarding, and, if not, forwarding the data frame from the backbone unsecured. Effectively, a conversion is performed at the boundary of the wireless network to the backbone. Traffic of unsecured frames is restricted by securing the frames if possible.

Optionally, in the border router the border controller is arranged for routing the joining messages between the nodes and the configurator. Alternatively, or additionally the routing may be performed at a further node, or by a dedicated router located in the network. In the border controller the routing may be arranged to only forward received unsecured data frames via the backbone if such frames are destined to a predefined destination address. The routing may also be arranged to, when in unsecured mode, prevent forwarding of data frames between the border transceiver and backbone transceiver.

In an embodiment of the proposed network system, the new network security state, i.e. the partially secure network security state, is added as follows. The new state is intermediate between a completely insecure open network and a completely secured closed network. In this state the network system has the following properties. The network is a mix of secured and unsecured devices randomly distributed (non-onion style).

In the embodiment unsecured devices behave as follows:
Device sends unsecured MAC data frames from its higher layers
Device accepts unsecured MAC data frames destined to its higher layers
Device routes/forwards only unsecured MAC data frames.

In the embodiment secured devices behave as follows:
Device sends only secured MAC data frames from its higher layers
Device accepts only secured MAC data frames destined to its higher layers
Device routes/forwards both unsecured and secured data frames using the following rules:
   If receiving an unsecured frame from an unsecured node and forwarding to an unsecured node, the frame is kept unsecured during forwarding
   If receiving an unsecured frame from an unsecured node and forwarding to a secured node, the frame is secured before forwarding
   If receiving a secured frame from a secured node and forwarding to an unsecured node, the frame is first unsecured before forwarding
   If receiving an unsecure frame from a secured node, the frame is dropped.
   Given two path options, the secured node gives preference to the path where the next hop is secured.
   Secured nodes force the joining messages to route only towards the border router and back to the new node, for example with a dedicated routing path for such messages.

In the embodiment the border router (BR) may be configured to route joining messages between the nodes and an authenticator, which usually resides in the configurator (which may be called a Commissioning Tool). The BR may also be configured with additional packet filtering in the partially secure network security state as follows:
BR will not forward unsecured packets originating from a Low power Wireless Personal Area Network (LowPAN) to the backbone (e.g. to limit impact of DoS) with the exception of specific (configured) destination addresses on the backbone (e.g. to the Commissioning Tool)
Packets from the backbone destined to nodes in the LowPAN are secured by BR at the MAC layer if the first hop node on the route is secured, else it is forwarded unsecured.

In a further embodiment the network system has nodes in a lighting network, which are joined to create a secure network using a commissioning process. It is described how a network of devices is installed and commissioned without any initial security and converted to a secured network in which only authorized devices send packets which cannot be modified or decrypted by unauthorized devices. Different security states for the networked devices are based on the link layer security configuration. The required link layer security configuration relates to how a device handles MAC data frame security (authentication and/or encryption) as specified by the IEEE 802.15.4 standard.

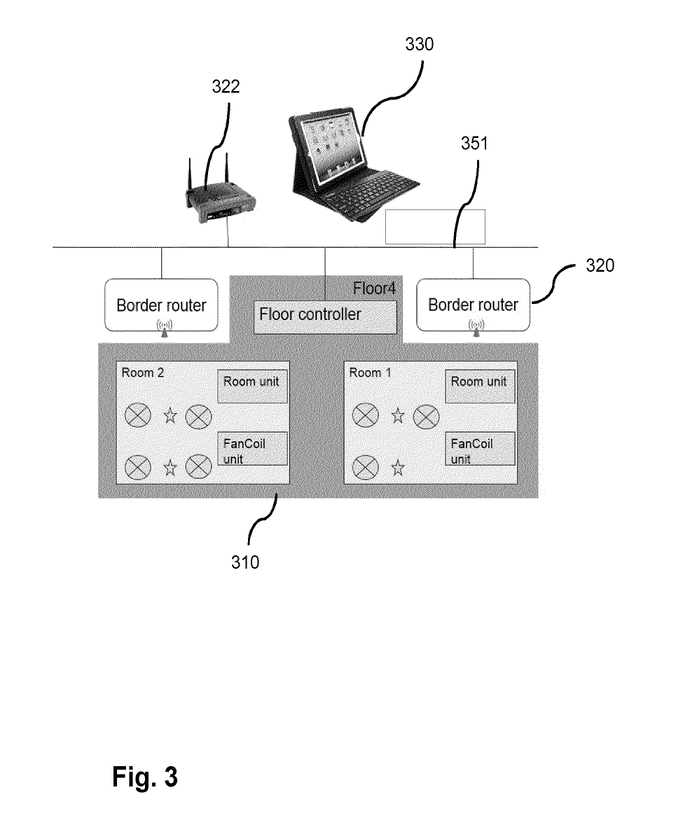

FIG. 3 shows an example of a topology of a network system. The Figure shows an example network topology. A number of network devices are installed in a building as shown on a schematically floor plan 310 called Floor4. On the floor plan a first node is a floor controller, while in a first room called ROOM1 a few light devices, a room unit and a fan unit have been installed. Each device also is a network device for constituting a node in the wireless network. Similarly, a second room called ROOM2 also has a number of network devices installed. A backbone 351, e.g. a wired network, is shown coupled to a few border routers 320, which border routers constitute nodes in the mesh type wireless network to support the wireless communication. FIG. 3 illustrates a practical example of network configuration. Floor4 is composed of two rooms on a building floor. Each element in the room represents a networked wireless node with a specific functionality. The functionalities are: four lamps (crossed circles), two sensors (stars), a thermostat (room unit) and a ventilator (fancoil unit, or ventilator). All devices in the two rooms constitute one LowPAN. In the example topology of FIG. 3 the wireless nodes are connected to a backbone via as many border routers as there are rooms. The floor controller of floor4 is directly connected to the backbone.

A configurator device 330, e.g. a laptop computer having appropriate communication circuitry and configurator software called a commissioning tool (CT), is shown for configuring the network system. The network is progressively secured at the link layer during the commissioning process. For example, the devices are connected in a LowPAN using IP on the network layer and IEEE 802.15.4 at the link and physical layers. The used IP protocols may be CoAP and UDP. The Commissioning tool (CT) is connected to the wireless nodes via an Access Point 322 that is connected to the backbone 351.

An example of a commissioning process is now described. The following is assumed before the commissioning process starts:
Border Routers are installed; and there is at least one Border Router. The BR may be factory configured with a factory secret key, but the key is not specific for this particular deployment and is therefore considered unsecure.
It is not required that Internet infrastructure functions are connected to the backbone. A number of lamps/switches/sensors are electrically installed, and may be supplied by different vendors. Initially the network device status is
Not yet connected to the Border Router.
A vendor-key (for example a Pre-Shared Key (PSK) or Certificate) is already present in nodes.
   The Commissioning Tool (CT) may communicate with a node via any of the connected Border Routers. Vendor-Keys (e.g. PSK or Certificate Authority (CA) trust anchors) for devices are stored in CT. Also Link-layer and application level keys to be commissioned to devices are stored in CT.

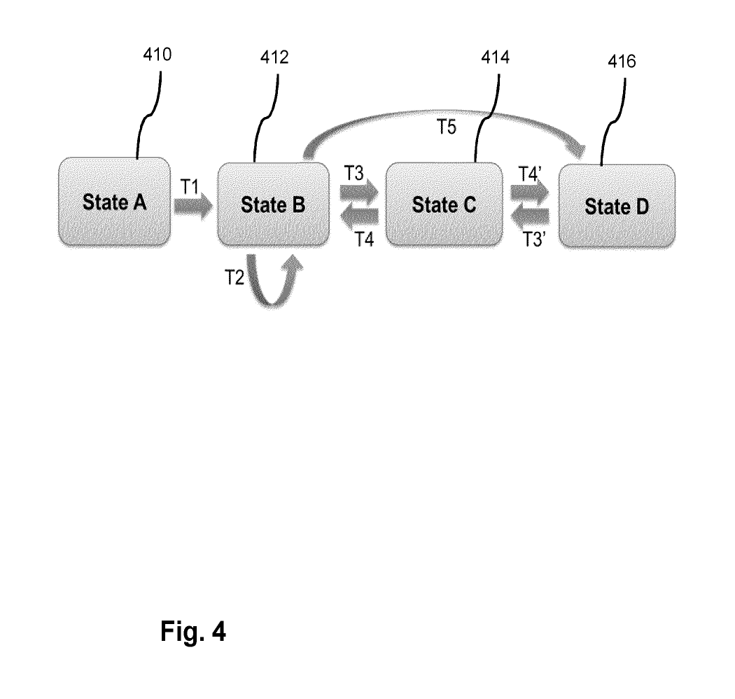

A network device needs to be provided with the security association (SA) attributes (keys etc. as defined by the IEEE 802.15.4 standard) as part of the commissioning process to configure the security services on the device. The network is set to a specific network security state by the CT as a function of the individual security modes of the nodes. The security mode of the nodes is set and monitored by the CT based on joining messages exchanged to the respective nodes. The commissioning process and the respective security states are elucidated with reference to the FIG. 4.

FIG. 4 shows an example of network security states and state transitions. Initially the network is fully unsecure and in a State A or initial state 410. By a transition T1 the state is set to State B or partially secure state 412. In State B multiple transitions T2 are possible. By a transition T3 the network progresses to State C or secure state 414, while a reverse transition T4 brings the network back to State B. Optionally, the system has a further state D or join state 416, which is reached by transition T4′ from state C or transition T5 from state B. A transition T3′ brings the state from state D back to state C. The states and transitions according to the example are further defined as follows.
STATE A: Insecure State: Open Network with all unsecured Devices:
All devices in the network are unsecured and behave as follows
   Device sends unsecured MAC data frames from its higher layers
   Device accepts unsecured MAC data frames destined to its higher layers
   Device routes/forwards only unsecured MAC data frames.
STATE B. Partially Secure State: Open Network with both secured and unsecured Devices. The network is a mix of secured and unsecured devices. All unsecured devices continue to behave as in State A. All secured devices behave as follows:
   Device sends only secured MAC data frames from its higher layers
   Device accepts only secured MAC data frames destined to its higher layers
   Device routes/forwards both unsecured and secured data frames using the following rules:
      If receiving an unsecured frame from an unsecured node and forwarding to an unsecured node, the frame is kept unsecured during forwarding
      If receiving an unsecured frame from an unsecured node and forwarding to a secured node, the frame is secured before forwarding
      If receiving a secured frame from a secured node and forwarding to an unsecured node, the frame is first unsecured before forwarding
      If receiving an unsecure frame from a secured node, the frame is dropped.
      Given two path options, the secured node gives preference to the path where the next hop is secured.
      Secured nodes force the joining messages to route only towards the BR and back to the new node, for example with a dedicated routing path for such messages.
STATE C. Secured State: Secure Network with all secured Devices:
All devices in the network including Border Routers are secured and behave as follows:
   Device sends only secured MAC data frames from its higher layers
   Device accepts only secured MAC data frames destined to its higher layers
   Device routes/forwards only secured MAC data frames and rejects all unsecured frames.
STATE D. Secured Join State: Secure Network with unsecured Join Devices on the edge.
All devices in the network including Border Routers are secured and behave as in the Secured State (C) with the exception of forwarding:
   Device routes/forwards only secured MAC data frames except the first hop joining messages from the unsecured Join Device.

The aim of the commissioning process is to bring the network from the initial or insecure state to a secured network security state. In the installation procedures three sub-installation procedures can be identified:
1. Creation of a secure network, in which a network in State A passes to State C.
2. Connection to the infrastructure, in which the Border Router of a network in State B or State C will become part of a larger wired network.
3. Addition of devices to secure network, in which a network in State C passes to a network in State B or State D and then back to State C.

The following security association (SA) attributes can be provisioned as part for the installation procedure:
1. “Link layer” SA for the MAC frames
2. “Transport level” SAs for the different applications
2.1. Unicast SAs (for mainly device to backend communication).
2.2. Multicast SAs (for mainly device to device communication).
   The installation procedures are explained in the following sections.

For Link-Layer SA installation the possible steps to go from one network security state to another are described now, with reference to FIG. 4. The Figure shows the security states of the network and the state transitions which are possible. The commissioning process implies the application of transition T1, the repetitive application of T2 for each device, and finally pass to the secured State C with T3 (or alternatively to the State D with T5). During the addition of new devices, State C is transitioned to either State B using T4 or alternatively to State D using T4′. After installation of the new device, the State B or State D is transitioned back to State C either using T3 or T3′. Three sub-installation procedures are described in detail now.

A first Link-Layer sub-installation procedure is Creation of a Secure network, having the stages:
1. At first, all Devices are switched on
   a. Devices automatically select the PANID and become part of the open mesh network that is formed (State A).
2. Next, the Commissioning Tool (CT) configures the (multiple) Border Routers (BR) following RFC4944
   a. Security configuration similar to other network devices is performed (detailed in step3).
   b. Other BR related (non-security) configurations need to be determined and performed
   c. The security service is enabled on the BR with security configuration is as in State B
3. The CT establishes a connection to one device (selected out-of-band) through the BR
   a. (Mutual) authentication between CT and device is performed at application layer (e.g. using DTLS), for example based on a Vendor-Key (PSK or Certificate) already present in the device
   b. Configure the device by transferring “Link Layer” Security Association attributes (link-layer operational keys, etc.) secured by Vendor-Key (or a derived session-key) at the application layer (e.g. using DTLS)
   c. Transition T1, CT enables security service on each configured device and network remains in State B with growing number of secured devices.
4. After CT configures all devices in the network.
   a. Transition T3, CT sends “network lockdown” message to all devices (including BR) in the network to transition from State B to State C
   b. Alternatively Transition T5, CT sends “only join edge” message to all devices (including BR) in the network to transition from State B to State D.
   c. Verify that all devices received this message.

A second Link-Layer sub-installation procedure is Connection to Backbone.

The connection to the backbone can be done at any time independently of the above sequence for creation of a secure network. Therefore the LowPAN can be either in State B, State C or State D (the LowPAN cannot be in State A since at least the BR's security service is enabled).
1. Connect BR to backbone
   a. Backbone interface is automatically configured on connection to backbone
2. Packet filtering and securing by the BR
   a. If the LowPAN is in State B:
      i. BR will not forward unsecured packets originating from LowPAN to the backbone (e.g. to limit impact of DoS) with the exception of specific (configured) destination addresses on the backbone (e.g. to the Commissioning Tool)
      ii. Packets from the backbone destined to nodes in the LowPAN are secured by BR at the MAC layer if the first hop node on the route is secured, else it is forwarded unsecured.
   b. If LowPAN is in State C
      i. BR will not forward any unsecured packets originating from LowPAN to backbone.
      ii. All packets from the backbone destined to devices in the LowPAN are secured by the BR at the MAC layer.
   c. If LowPAN is in State D
      i. BR will not forward any unsecured packets originating from LowPAN to backbone unless the joining device is 1-hop from BR
      ii. All packets from the backbone destined to devices in the LowPAN are secured by the BR at the MAC layer unless the joining device is 1-hop from BR.

A third Link-Layer sub-installation procedure is addition of new device to a secured network, having the stages:
1. Assuming network is in State C
   a. Transition T4, move network from State C to State B using a network wide message and proceed as described for adding nodes in the section “creation of a secure network”.
   b. Alternatively transition T4′, move network from State C to State D using a network wide message and proceed as above.
   c. Transition the network back to State C either with transition T3 or T3′ with a network wide lockdown message.

On a further layer also security attributes may be established, for example Application layer SA installation. Other operational applications (like backend data transfer) need to be configured with the appropriate application layer SAs. This configuration can be performed as part of “Link Layer” SA installation in Step 3 with additional “Transport level” SAs for the different applications:
Unicast SAs for mainly device to backend communication.
Multicast SAs for mainly device to device communication.
   After the device has been transitioned to State B, State C or State D:
Applications that do not have “Transport level” SA's configured, send and receive messages secured only at the MAC layer.
Applications that have “Transport level” SA's configured, can send and receive messages secured both at transport (e.g. using DTLS) and at MAC layer.

Although the invention has been mainly explained by embodiments using specific standards, the invention is also suitable for any wireless network that has a meshed, multi-hop structure. For example, the present invention may be part of the commissioning process of IP based wireless lighting based on IEEE 802.15.4 link layer. Such networked based lighting may be an integral part of the future building management systems. The same network access mechanisms can be used for creating a secure building management network with wireless sensors (thermostats etc.) and actuators (fans etc.) used for building controls. The invention can be further applied broadly in the Internet-of-Things domain where easy and efficient network setup is required without large resources in end-devices. Such applications can be in the home controls or smarty-city outdoor controls.

It is to be noted that the invention may be implemented in hardware and/or software, using programmable components. The functions described above, implemented in various devices in the network system as described above, may be performed by the following methods.

A method of configuring for use in the network system may comprise determining network security states including an insecure state in which all nodes are in the unsecured mode and the network is open for joining nodes; a partially secure state in which at least one node is in the secured mode and the network is open for joining nodes; and a secure state in which the network is closed to nodes in the unsecured mode.

A method of controlling a network device for use in the network system may comprise, according a detected network security state, controlling a transceiver on a network layer and transferring data frames between the transceiver and higher communication layers in the network device. The method further includes, when in unsecured mode, controlling data frames from the higher communication layers to be transmitted unsecured; controlling received unsecured data frames, if destined to the network device, to be accepted by the higher communication layers; and forwarding received data frames to the further nodes. The method further includes, when in secured mode, controlling data frames from the higher communication layers to be transmitted secured; controlling received secured data frames, if destined to the network device, to be accepted by the higher communication layers. The method further includes, when the detected network security state is the partially secure state, forwarding received data frames to the further nodes; and when the detected network security state is the secure state, dropping received unsecured data frames and forwarding received secured data frames to the further nodes.

A method of controlling a border router for use in the network system may comprise according to a detected network security state, controlling a border transceiver and a backbone transceiver on a network layer, when in unsecured mode, forwarding received data frames to the further nodes. The method further includes, when in secured mode and when the detected network security state is the partially secure state, forwarding received data frames to the further nodes or the backbone; and when in secured mode and when the detected network security state is the secure state, dropping received unsecured data frames and forwarding received secured data frames to further nodes or the backbone.

A computer program product for wireless networking may contain a program operative to cause a processor to perform any of the above methods.

It will be appreciated that, for clarity, the above description has described embodiments of the invention with reference to different functional units and processors. However, it will be apparent that any suitable distribution of functionality between different functional units or processors may be used without deviating from the invention. For example, functionality illustrated to be performed by separate units, processors or controllers may be performed by the same processor or controllers. Hence, references to specific functional units are only to be seen as references to suitable means for providing the described functionality rather than indicative of a strict logical or physical structure or organization. The invention can be implemented in any suitable form including hardware, software, firmware or any combination of these.

It is noted that in this document the word ‘comprising’ does not exclude the presence of elements or steps other than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software, and a processor may fulfill the function of one or more units, possibly in cooperation with hardware elements. Further, the invention is not limited to the embodiments, and the invention lies in each and every novel feature or combination of features described above or recited in mutually different dependent claims.

### Reference Documents:

[IEEE15.4] IEEE Computer Society, IEEE Standard 802.15.4-2011.

[6LoWPAN] RFC 4944, Transmission of IPv6 Packets over IEEE 802.15.4 Networks

[CoAP] RFC 7252, The Constrained Application Protocol (CoAP)

[AES] Advanced Encryption Standard (AES), Federal Information Processing Standards Publication 197. United States National Institute of Standards and Technology (NIST).

[AES-CCM] RFC 3610, Counter with CBC-MAC (CCM)

[IPSec] RFC 6040, Security Architecture for the Internet Protocol

[DTLS] RFC 6347, Datagram Transport Layer Security Version 1.2

[EAP] RFC 3748, Extensible Authentication Protocol (EAP)

[RADIUS] RFC 2865, Remote Authentication Dial In User Service (RADIUS)

[PANA] RFC 5191, Protocol for Carrying Authentication for Network Access (PANA)

[PRE] RFC 6345, Protocol for Carrying Authentication for Network Access (PANA) Relay Element

1. Network system comprising network devices, a border router and a configurator,
the network devices and the border router constituting nodes in a wireless network having a mesh structure of wireless communication links between the nodes, and
the border router being connected to a backbone,
the wireless network enabling a joining node, which is operating in an unsecured mode, to join the wireless network by exchanging joining messages with the configurator, which configurator authenticates the joining node based on the joining messages and enables, via the joining messages, the joining node to operate in a secured mode,
the configurator comprising a configurator controller arranged for determining network security states including
an insecure state in which all nodes are in the unsecured mode and the wireless network is open for joining nodes;
a partially secure state in which at least one node is in the secured mode and the wireless network is open for joining nodes;
a secure state in which the wireless network is closed to nodes in the unsecured mode;
each one of the network devices comprising
a transceiver for wirelessly receiving data frames from neighboring nodes and transmitting data frames to the neighboring nodes,
a device controller for, according a detected network security state, controlling the transceiver on a network layer and transferring data frames between the transceiver and higher communication layers in the network device,
the device controller being arranged for, when in unsecured mode,
controlling data frames from the higher communication layers to be transmitted unsecured;
controlling received unsecured data frames, if destined to the network device, to be accepted by the higher communication layers;
forwarding received unsecured data frames to the further nodes; and
the device controller being arranged for, when in secured mode,
controlling data frames from the higher communication layers to be transmitted secured;
controlling received secured data frames, if destined to the network device, to be accepted by the higher communication layers;
when the detected network security state is the partially secure state, forwarding received unsecured and secured data frames to the further nodes; and
when the detected network security state is the secure state, dropping received unsecured data frames and forwarding received secured data frames to the further nodes,
the border router comprising
a border transceiver for wirelessly receiving data frames from neighboring nodes and transmitting data frames to the neighboring nodes,
a backbone transceiver for receiving data frames from the backbone and transmitting data frames to the backbone,
a border controller for, according to a detected network security state, controlling the border transceiver and the backbone transceiver on a network layer, the border controller being arranged for, when in unsecured mode,
forwarding received unsecured data frames to the further nodes, the border controller being arranged for, when in secured mode,
when the detected network security state is the partially secure state, forwarding received unsecured and secured data frames to the further nodes or the backbone; and
when the detected network security state is the secure state, dropping received unsecured data frames and forwarding received secured data frames to further nodes or the backbone.

2. Network system as claimed in claim 1, wherein in the configurator, the configurator controller is arranged for determining the network security states by
sending a network lock message to set the network security state to the secure state;
sending a network unlock message to set the network security state to the partially secure state;
in the network device, the device controller is arranged for setting the detected network security state to the secure state when receiving the network lock message, and for setting the detected network security state to the partially secure state when receiving the network unlock message.

3. Network system as claimed in claim 1, wherein in the configurator, the configurator controller is arranged for determining as a further network security state
a join state in which the wireless network is closed and the nodes are in the secured mode while enabling joining of a joining node in the unsecured mode and one-hop away of a node in the secured mode;
in the network device, the device controller is arranged for, when in secured mode,
when the detected network security state is the join state, forwarding received secured data frames to the joining node after unsecuring; and forwarding received unsecure data frames from the joining node after securing,
in the border router, the border controller is arranged for, when in secured mode,
when the detected network security state is the join state, forwarding received secured data frames to the joining node after unsecuring; and forwarding received unsecure data frames from the joining node after securing.

4. Network system as claimed in claim 3, wherein
in the configurator, the configurator controller is arranged for determining the network security states by
sending a join edge message to set the network security state to the join state;
in the network device, the device controller is arranged for setting the detected network security state to the join state when receiving the join edge message.

5. Network system as claimed in claim 1, wherein
in the network device, the device controller is arranged for, when the detected network security state is the partially secure state and if routing enables two paths, routing to the path where the next link is secured;
in the border router, the border controller is arranged for, when the detected network security state is the partially secure state and if routing enables two paths, routing to the path where the next link is secured.

6. Network system as claimed in claim 1, wherein
in the network device, the device controller is arranged for, when the detected network security state is the partially secure state,
if receiving an unsecured frame from an unsecured node and forwarding to an unsecured node, the frame is forwarded unsecured;
if receiving an unsecured frame from an unsecured node and forwarding to a secured node, the frame is secured before forwarding;
if receiving a secured frame from an secured node and forwarding to an unsecured node, the frame is first unsecured before forwarding;
if receiving an unsecure frame from a secured node, the frame is dropped.

7. Network system as claimed in claim 1, wherein
in the network device, the device controller is arranged for
routing the joining messages from the joining node only towards the border router and joining messages from the border router back to the joining node,
in the border router, the border controller is arranged for
routing the joining messages from the joining node only towards the border router and joining messages from the border router back to the joining node, and/or
if a first communication link in a path is to a secured node, securing a data frame from the backbone and then forwarding, and, if not, forwarding the data frame from the backbone unsecured.

8. Configurator for use in the network system as defined in claim 1, the configurator for authenticating a joining node based on joining messages and enabling, via the joining messages, the joining node to operate in a secured mode, the configurator comprising a configurator controller as defined in claim 1.

9. Network device for use in the network system as defined in claim 1, the network device comprising
a transceiver for wirelessly receiving data frames from neighboring nodes and transmitting data frames to the neighboring nodes,
a device controller as defined in claim 1 for, according a detected network security state, controlling the transceiver on a network layer and transferring data frames between the transceiver and higher communication layers in the network device.

10. Border router for use in the network system as defined in claim 1, the border router comprising
a border transceiver for wirelessly receiving data frames from neighboring nodes and transmitting data frames to the neighboring nodes,
a backbone transceiver for receiving data frames from the backbone and transmitting data frames to the backbone,
a border controller as defined in claim 1 for, according to a detected network security state, controlling the border transceiver and the backbone transceiver on a network layer.

11. Border router as claimed in claim 10, wherein the border controller, is arranged for
routing the joining messages between the nodes and the configurator, and/or
only forwarding received unsecured data frames via the backbone if destined to a predefined destination address, and/or
when in unsecured mode, prevents forwarding of data frames between the border transceiver and backbone transceiver.

12. Method of configuring for use in the network system as defined in claim 1, the method comprising
authenticating a joining node based on joining messages and enabling, via the joining messages, the joining node to operate in a secured mode, and
determining network security states including
an insecure state in which all nodes are in the unsecured mode and the wireless network is open for joining nodes;
a partially secure state in which at least one node is in the secured mode and the wireless network is open for joining nodes;
a secure state in which the wireless network is closed to nodes in the unsecured mode.

13. Method of controlling a network device for use in the network system as defined in claim 1, the method comprising
according a detected network security state, controlling a transceiver on a network layer and transferring data frames between the transceiver and higher communication layers in the network device,
when in unsecured mode,
controlling data frames from the higher communication layers to be transmitted unsecured;
controlling received unsecured data frames, if destined to the network device, to be accepted by the higher communication layers;
forwarding received unsecured data frames to the further nodes; and
when in secured mode,
controlling data frames from the higher communication layers to be transmitted secured;
controlling received secured data frames, if destined to the network device, to be accepted by the higher communication layers;
when the detected network security state is the partially secure state, forwarding received unsecured and secured data frames to the further nodes; and
when the detected network security state is the secure state, dropping received unsecured data frames and forwarding received secured data frames to the further nodes.

14. Method of controlling a border router for use in the network system as defined in claim 1, the method comprising
according to a detected network security state, controlling a border transceiver and a backbone transceiver on a network layer,
when in unsecured mode, forwarding received unsecured data frames to the further nodes,
when in secured mode and when the detected network security state is the partially secure state, forwarding received unsecured and secured data frames to the further nodes or the backbone; and
when in secured mode and when the detected network security state is the secure state, dropping received unsecured data frames and forwarding received secured data frames to further nodes or the backbone.

15. Computer program product for wireless networking, which program is operative to cause a processor to perform the method as claimed in claim 1.
